(19) United States
(12) Patent Application Publication
(10) Pub. No.: US 2004/0209780 A1
(43) Pub. Date: Oct. 21, 2004

(54) Methods of treating subterranean formations using hydrophobically modified polymers and compositions of the same

(76) Inventors: Phillip C. Harris, Duncan, OK (US); Stanley J. Heath, Duncan, OK (US); Gary P. Funkhouser, Duncan, OK (US)

Correspondence Address: Robert A. Kent, Halliburton Energy Services, 2600 South 2nd Street, Duncan, OK, 73536-0440, US

(21) Appl. No.: 10/419,013

(22) Filed: Apr. 18, 2003

(51) Int. Cl. C09K 7/02; E21B 43/00

(52) U.S. Cl. 507/117; 507/219

(57) ABSTRACT

Methods for treating subterranean formations, hydrophobically modified polymer compositions and fracturing fluid compositions containing hydrophobically modified polymer are provided. The hydrophobically modified polymer compositions wherein a plurality of hydrophobic groups are formed on the polymer, are basically comprised of water, a charged polymer, and surfactant. The surfactant has a charge opposite to that of the polymer and is capable of forming ion-pair associations with the polymer.

### FIELD OF THE INVENTION

The present invention relates to improved methods for fracturing a subterranean formation and hydrophobically modified polymer compositions for treating subterranean formations.

### BACKGROUND OF THE INVENTION

Hydraulic fracturing operations are often carried out on oil and gas wells to increase the flow of oil and natural gas therefrom. For example, the fracturing fluid creates fractures in the formation and transports and deposits proppants into the fractures. The proppants hold the fractures open after the fracturing fluid flows back into the well. To adequately propagate fractures in subterranean formations, the fracturing fluid should exhibit minimal fluid loss into the formation and should have sufficient viscosity to carry large volumes of proppant into the cracks in the formation formed during fracturing. The fracturing fluid, however, should also readily flow back into the well after the fracturing operation is complete, without leaving residues that impair permeability and conductivity of the formation.

In order to increase the viscosity of fracturing fluids, hydratable high molecular weight polymers such as polysaccharides, polyacrylamides and polyacrylamide copolymers are often added to the fluids. The viscosity can be further increased by adding crosslinking compounds to the fluids. The term “crosslink” is used herein to refer to “an attachment of two chains of polymer molecules by bridges, composed of either an element, a group, or a compound that joins certain atoms of the chains by association.” Conventional crosslinking agents such as polyvalent metal ions or borate ions form chemical bonds between the viscosifier polymer molecules which raise the viscosity of the solution. In order to allow the crosslinked fluid to flow back out of the formation and into the well, a breaker is sometimes added to the fracturing fluid to degrade the molecular weight and thereby reduce the viscosity of the fracturing fluid.

Viscoelastic surfactants have also been added to fracturing fluids to increase the viscosity thereof. For example, gels can be formed by the association of hydrophobic portions of surfactants to form micelles or larger associative structures. The micelles or other associative structures increase the viscosity of the base fluid. As used herein, the term “micelle” is defined as “a colloidal particle composed of aggregates of surfactant molecules.”

During the fracturing operation, the polymers and other compounds used to increase the viscosity of the fracturing fluid desirably form a film over the fracture matrix, referred to as a “filtercake.” The filtercake prevents excessive fluid leakage into or out of the formation. After the fracturing operation is complete, however, as much of the filtercake as possible must be removed. Otherwise, it impedes the flow of oil and gas into the well bore. In particular, filtercakes deposited from conventional crosslinked fracturing fluids can be difficult to remove and can significantly interfere with oil and gas production.

As an alternative, hydrophobically modified polymers (“HMPs”) have been utilized to thicken and raise the viscosity of fracturing fluids. Micellar bonds are formed between hydrophobic groups on the polymers which result in a three-dimensional associated network and thereby increase the viscosity of the fluids. Surfactants are used to promote the formation of the micellar bonds. As used herein, the terms “micellar associations” or “micellar bonds” refer to those associative interactions between hydrophobic groups on HMP molecules.

Unlike conventional crosslinked fracturing fluids, the micellar associations between hydrophobic groups of HMPs are weaker than covalent chemical bonds and are thus more easily disrupted. The bonding strength of a micellar association is less than the bonding strength obtained from the chemical complex formation utilizing polyvalent metal and borate ion conventional crosslinkers. The enhanced reversibility of a micellar association minimizes the likelihood of damage to a reservoir allowing easier removal of the fracturing fluid from the fractured reservoir. By disrupting the miceller bonds, the polymer reverts back to “unassociated” polymer and the viscosity of the solution is substantially decreased. HMP fracturing fluids also leave less residual filtercake than conventional crosslinked fluids, resulting in improved post fracture conductivity and formation permeability. Unfortunately, HMPs produced by known methods and utilized in known processes are very limited in number.

Thus, there are needs for a broader array of HMPs. Furthermore, there are needs for improved methods of using HMPs for treating and fracturing a subterranean zone in a formation penetrated by a wellbore.

### SUMMARY OF THE INVENTION

By the present invention, methods of using treating fluid compositions in subterranean formation treatment, and treating fluid compositions are provided which meet the above-described needs and overcome the deficiencies of the prior art. The methods of treating subterranean formations comprise the following steps. A treating fluid composition is prepared comprising water, a charged polymer, and a surfactant having a charge that is opposite of the charged polymer. The surfactant is capable of forming ion-pair associations with the polymer resulting in a hydrophobically modified polymer having a plurality of hydrophobic groups. The resulting treating fluid composition is injected into a wellbore to treat a subterranean formation.

The current invention also provides methods for forming one or more fractures in a subterranean zone penetrated by a wellbore comprising the following steps. A treating fluid composition is prepared comprising water, a charged polymer, and a surfactant having a charge that is opposite of the charged polymer. The surfactant is capable of forming ion-pair associations with the polymer resulting in a hydrophobically modified polymer having a plurality of hydrophobic groups. The treating fluid is introduced into a subterranean zone through a wellbore under conditions effective to create at least one fracture. The treating fluid may also contain a proppant material.

Also, the current invention provides an improved method for fracturing a subterranean zone penetrated by a well bore by utilizing a foamed fracturing fluid. The foamed fracturing fluid composition is prepared comprising water, a charged polymer, a surfactant having a charge that is opposite of the charged polymer, an effective amount of foaming agent and sufficient gas to form a foam. The surfactant is capable of forming ion-pair associations with the polymer resulting in a hydrophobically modified polymer having a plurality of hydrophobic groups. The surfactant may also function as the foaming agent. The foamed fracturing fluid is introduced into the subterranean zone through the well bore under conditions effective to create at least one fracture.

Additionally, the current invention provides treating fluid compositions comprising water, a charged polymer, and a surfactant having a charge that is opposite of the charged polymer. The surfactant is capable of forming ion-pair associations with the polymer resulting in a hydrophobically modified polymer having a plurality of hydrophobic groups.

The objects, features and advantages of the present invention will be readily apparent to those skilled in the art upon a reading of the description of preferred embodiments which follows.

### BRIEF DESCRIPTION OF THE DRAWINGS

FIG. 1 shows the ion-pair association between a cationic polymer and an anionic surfactant to form a hydrophobically modified polymer.

FIG. 2 shows micellar associations between hydrophobic groups on adjacent hydrophobically modified polymers, formed by further addition of the surfactant.

### DESCRIPTION OF THE PREFERRED EMBODIMENTS

Preferred methods of this invention for treating a subterranean formation basically comprise the following steps. A treating fluid composition is prepared comprising water, a charged polymer, and a surfactant having a charge that is opposite of the charged polymer. The surfactant is capable of forming ion-pair associations with the polymer resulting in a hydrophobically modified polymer having a plurality of hydrophobic groups. The resulting treating fluid composition is injected into a wellbore to treat a subterranean formation. A non-limiting list of subterranean treatments contemplated by the current invention would include: fracturing, gravel packing, drilling and well bore or pipeline cleaning operations.

The treating fluid composition is prepared by combining and mixing a known volume or weight of water, polymer and surfactant using mixing procedures known to those skilled in the art.

It has been discovered that hydrophobically modified polymers, “HMPs” can be produced by utilizing the charge attraction of cations for anions. This method of producing an HMP is simplified compared to prior art methods in that a specialized chemical reactor is not required. Prior art methods required a reactor capable of maintaining the elevated temperatures and pressures needed to form covalent bonds of chemically reactive HMPs. Rather than chemically reacting polymers with hydrophobic hydrocarbon units, the current invention prepares an HMP by adding a cationic surfactant to an anionic polymer or by adding an anionic surfactant to a cationic polymer.

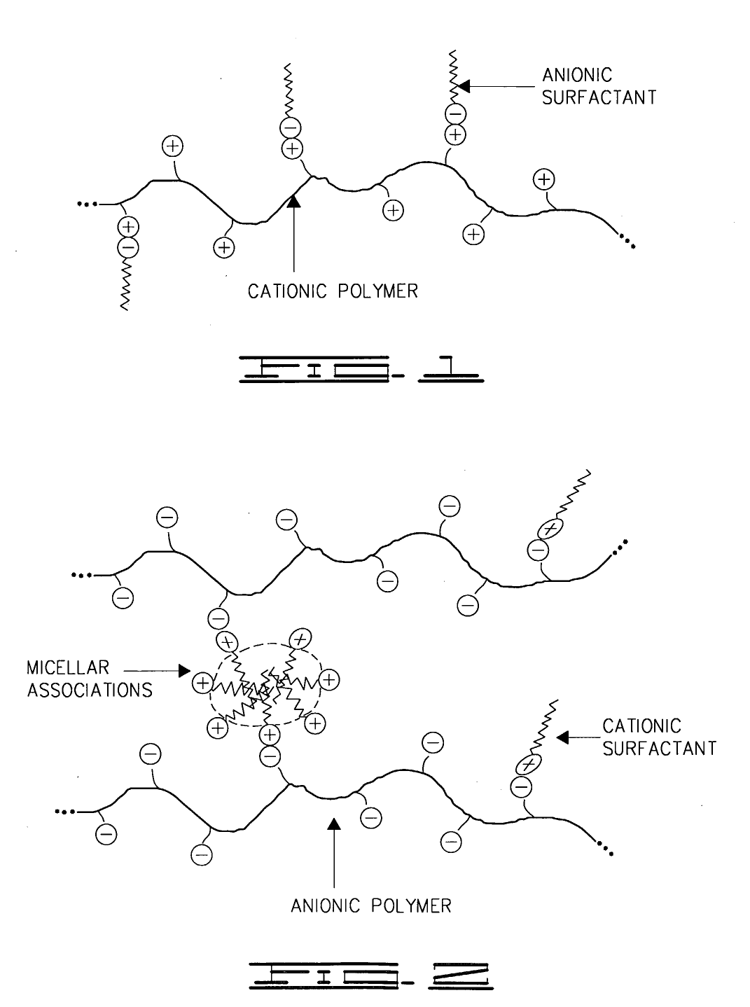

As depicted in FIG. 1, the resulting ion-pair association between the polymer and the surfactant forms a plurality of hydrophobic groups on or associated with the polymer. Without being limited to any single theory, it is believed that continued addition of surfactant leads to the formation of micellar bonds between hydrophobic groups on a single HMP molecule. The HMPs can also form crosslinks through micellar association of the surfactant associated with adjacent HMP molecules as shown in FIG. 2. Charged micelles may also be present in solution.

As the number of crosslinks associated with HMPs in the treating solution composition increases, the viscosity of the composition also increases. However, due to the nature of the bond joining the hydrophobic groups to the polymer, the resulting crosslinks are easily disrupted. Accordingly, exposure of the treating solution to high shear, excessive temperature or dilution with water will disrupt the micelles thereby causing the crosslinked HMP to revert to an uncrosslinked polymer solution.

The water utilized in the treating solution composition of this invention can be fresh water or salt water depending upon the particular density and the composition required. The term “salt water” is used herein to mean unsaturated salt water including unsaturated brines and sea water. Salts such as potassium chloride, sodium chloride, ammonium chloride, calcium chloride and other salts known to those skilled in the art may be added to the water to inhibit the swelling of the clays in the subterranean formations so long as the salt does not adversely react with other components of the composition. The water is included in the treating solution composition in an amount ranging from about 95% to about 99.9% by weight thereof, more preferably from about 98% to about 99.5%.

The term “polymer” is defined herein to include copolymers. The charged polymer utilized in the compositions of this invention can be either anionic or cationic. Examples of anionic polymers include, but are not limited to, carboxymethyl guar, carboxymethylhydroxypropyl guar, carboxymethylhydroxyethyl cellulose, polyacrylic acid, polyacrylate copolymers, 2-acrylamido-2-methylpropanesulfonic acid and salts and mixtures thereof. A preferred anionic polymer is carboxymethylhydroxypropyl guar. Examples of suitable cationic polymers include, but are not limited to, cationic polyacrylamide copolymers, cationic guar, cationic cellulose derivatives, cationic polysaccharide derivatives, choline methacrylate, and mixtures thereof. A preferred cationic polymer is cationic guar. The polymer is generally present in the HMP composition in an amount in the range of from about 0.1% to about 2.0% by weight thereof, more preferably from about 0.15% to about 0.5%, and most preferably in an amount of about 0.5%.

Surfactants with longer hydrophobic units are generally preferred for their ability to impart higher temperature tolerance and to increase the stability of the micelles. Cationic surfactants which can be used with anionic polymers include, but are not limited to, trimethylcocoammonium chloride, trimethyltallowammonium chloride, dimethyldicocoammonium chloride, bis(2-hydroxyethyl)tallowamine, bis(2-hydroxyethyl)erucylamine, bis(2-hydroxyethyl)coco-amine, cetylpyridinium chloride, and mixtures thereof. A preferred cationic surfactant is trimethyltallowammonium chloride.

Suitable anionic surfactants which can be used with cationic polymers include, but are not limited to, alpha olefin sulfonate, alkylether sulfates, alkyl phosphonates, alkane sulfonates, fatty acid salts, and arylsulfonic acid salts, and mixtures thereof. A preferred anionic surfactant is alpha olefin sulfonate having a chain length of 14 to 16 carbon atoms.

Generally, the surfactant is present in the treating fluid composition in an amount sufficient to form an ion-pair association with enough of the charged polymer units to produce an increase in viscosity. Preferably, the surfactant is present in the treating fluid composition in an amount in the range of from about 0.05% to about 1.0% by weight thereof, more preferably from about 0.1% to about 0.6%, and most preferably from about 0.2% to about 0.5%.

Certain viscosity-enhancing agents are capable of enhancing the formation of micellar bonds between hydrophobic groups on the polymer and/or between hydrophobic groups on adjacent polymer molecules. When added to the treating fluid composition, these agents further increase the viscosity of the composition. Suitable viscosity-enhancing agents include, but are not limited to, fatty alcohols, ethoxylated fatty alcohols, and amine oxides having hydrophobic chain lengths of 6 to 22 carbon atoms, and mixtures thereof. The viscosity-enhancing agent may increase the viscosity of the composition above that attainable by the polymer and surfactant alone. The viscosity-enhancing agent may also make the composition less sensitive to phase separation. When included in the treating fluid composition, the viscosity-enhancing agent is preferably present in an amount ranging from about 0.05% to about 1.0% thereof, and more preferably from about 0.1% to about 0.6%.

The current invention also provides an improved method for fracturing a subterranean zone penetrated by a well bore. The improved method utilizes a fracturing fluid composition comprising water, a charged polymer, and a surfactant having a charge that is opposite of the charged polymer. The surfactant is capable of forming ion-pair associations with the polymer resulting in a hydrophobically modified polymer having a plurality of hydrophobic groups. The fracturing fluid composition may optionally contain a viscosity-enhancing agent. The fracturing fluid composition has a viscosity suitable for fracturing the formation according to fracturing methods known to those skilled in the art, and is introduced into the subterranean zone through the well bore under conditions effective to create at least one fracture.

Preferably the fracturing fluid further comprises a proppant. In general, proppants must have sufficient compressive strength to resist crushing, but also be sufficiently non-abrasive and non-angular to preclude cutting and embedding into the formation. Suitable proppant material includes but is not limited to, sand, graded gravel, glass beads, sintered bauxite, resin-coated sand, ceramics, and intermediate-strength ceramics. Preferably, proppants are present in the fracturing fluid composition in an amount in the range of from about 0.5 lb/gal to about 24 lb/gal thereof, more preferably from about 1 lb/gal to about 12 lb/gal.

The fracturing fluid exhibits a relatively low friction pressure and is shear rehealing, that is, the micellar bond “crosslink” is disrupted with shear. At high shear rates in the wellbore, the system energy may be high enough to break down the crosslink and thin the fluid, but at the lower shear rates experienced in the fracture, the crosslink reforms and viscosity increases thereby improving proppant transport when present.

When using proppant material, after a specified amount of proppant is deposited into the formation, the wellbore is shut in by closing a valve at the surface for a period of time sufficient to permit stabilization of the subterranean formation. Contact with formation fluids such as oil and brine breaks the micellar bonds of the fracturing fluid thereby reducing the viscosity and allowing it to be recovered from the subterranean formation. Chemical breakers may also be included to degrade the polymer backbone thereby lowering the viscosity of the fracturing fluid composition. Following the reduction in viscosity, the fracturing fluid composition flows out of the fracture leaving the proppant material, when present, behind to hold the fractures open. Since conventional polyvalent metal and borate ion crosslinking agents are not required, filter cake on the walls of the well bore is more easily removed, providing for improved well performance.

A viscosity-enhancing agent may optionally be added to the fracturing fluid composition. The viscosity-enhancing agent is capable of enhancing the formation of micellar bonds between hydrophobic groups on the polymer and/or between the hydrophobic groups on adjacent polymer molecules. Suitable viscosity-enhancing agents include, but are not limited to, fatty alcohols, ethoxylated fatty alcohols and amine oxides having hydrophobic chain lengths of 6 to 22 carbon atoms, and mixtures thereof. Preferably, the viscosity-enhancing agent is present in the fracturing fluid composition in an amount in the range of from about 0.05% to about 1.0% thereof, and more preferably from about 0.1% to about 0.6%.

A variety of lightweight fracturing fluids have been developed and used including foamed fracturing fluids. The advantage of foamed fracturing fluids is that they cause less damage to the formation than non-foamed fracturing fluids. Foams contain less liquid and have less tendency to leak into the matrix of the rock formation. Also, the sudden expansion of gas in the foams when the pressure in the well is relieved promotes the flow of fracturing fluid back out of the formation and into the well after the fracturing operation is complete.

The current invention provides an improved method for fracturing a subterranean zone penetrated by a well bore by utilizing a foamed fracturing fluid. The foamed fracturing fluid composition is prepared comprising water, a charged polymer, a surfactant having a charge that is opposite of the charged polymer, an effective amount of foaming agent and sufficient gas to form a foam. The surfactant is capable of forming ion-pair associations with the polymer resulting in a hydrophobically modified polymer having a plurality of hydrophobic groups. The surfactant may also function as the foaming agent. The fracturing fluid composition may optionally contain proppant and a viscosity-enhancing agent. The foamed fracturing fluid composition has a viscosity suitable for fracturing the formation according to fracturing methods known to those skilled in the art, and is introduced into the subterranean zone through the well bore under conditions effective to create at least one fracture.

Examples of gases suitable for foaming the fracturing fluid of this invention are air, nitrogen, carbon dioxide and mixtures thereof. The gas may be present in the fracturing fluid in an amount in the range of from about 10% to about 95% by volume of liquid, preferably from about 20% to about 90%, and most preferably from about 20% to about 80% by volume.

Examples of foaming agents that may be utilized in the present invention include cationic surfactants such as quaternary compounds or protonated amines with hydrophobic groups having a chain length of from about 6 to 22 carbon atoms. Such compounds include but are not limited to trimethylcocoammonium chloride, trimethyltallowammonium chloride, dimethyldicocoammonium chloride, bis(2-hydroxyethyl)tallowamine, bis(2-hydroxyethyl)erucylamine, bis(2-hydroxyethyl)coco-amine, cetylpyridinium chloride, and mixtures thereof. Other suitable foaming agents include, but are not limited to, anionic surfactants having a chain length of from about 6 to about 22 carbon atoms such as alpha olefin sulfonate, alkylether sulfates, alkyl phosphonates, alkane sulfonates, fatty acid salts, and arylsulfonic acid salts. Preferred foaming agents include trimethyltallowammonium chloride and alphaolefin sulfonate having a chain length of 14 to 16 carbon atoms. The surfactant used in the present invention for forming hydrophobically modified polymer may also function as the foaming agent. Preferably, the foaming agent is present in the foamed fracturing fluid in an amount in the range of from about 0.1% to about 2.0% by weight thereof. If the foaming agent is the same as the surfactant used in the fracturing fluid composition, then this quantity should be used in addition to the surfactant required for hydrophobically modified polymer formation.

The treating fluid compositions of this invention, wherein a plurality of hydrophobic groups are formed on a polymer, comprise water, a charged polymer, and a surfactant having a charge that is opposite to that of the charged polymer and capable of forming ion-pair associations with the polymer. A viscosity-enhancing agent may be added to the treating fluid composition to increase the viscosity of the fluid. As will be understood by those skilled in the art, a variety of conventional additives can be included in the treating fluid composition such as gel stabilizers, gel breakers, clay stabilizers, bactericides, fluid loss additives and the like which do not adversely react with the hydrophobically modified polymer.

A preferred method of this invention for treating a subterranean formation comprises the steps of: (a) preparing a treating fluid composition comprising water, a charged polymer, and a surfactant having a charge that is opposite to that of the charged polymer, the surfactant being capable of forming an ion-pair association with the polymer resulting in a hydrophobically modified polymer having a plurality of hydrophobic groups; and (b) injecting the treating fluid composition into a well bore to treat the subterranean formation.

In order to further illustrate the compositions and methods of the present invention, the following examples are given.

### EXAMPLE 1

An aqueous solution of carboxymethylhydroxypropyl guar (CMHPG) was prepared by adding 4.8 g CMHPG to 1 L of water in a blender jar. The polymer was allowed to hydrate for fifteen minutes at pH 7. A 100 mL aliquot of the hydrated CMHPG fluid was placed into another blender jar and the cationic surfactant trimethyl cocoammonium chloride was added to the CMHPG fluid in quantities ranging from 0.02 mL to 0.5 mL. The viscosity of the mixture was measured using a Fann 35 viscometer at a shear rate of 511 sec⁻¹ at different concentrations of trimethyl cocoammonium chloride. Table 1 shows the increase in viscosity with increasing trimethyl cocoammonium chloride concentration.

TABLE 1
Effect of Anionic Polymer on Viscosity

| Trimethylcocoammonium | Viscosity @ 511 s⁻¹ |
|---|---|
| Chloride, % | cP |
| 0.0 | 32.7 |
| 0.1 | 46.3 |
| 0.2 | 57.5 |
| 0.3 | 42.5 |

Increasing the blender speed from slow to moderate caused the mixture to foam due to entrained air. An increase in the volume of the fluid from 100 mL to 360 mL was observed due to stirring. The foam was transferred to a 1 L graduated cylinder. A time of forty-four minutes was required to drain one-half of the liquid from the foam, indicating substantial stability of the foam.

### EXAMPLE 2

A 350 mL blender jar was charged with 300 mL of Duncan, Okla. tap water. While shearing, 3.0 g of quaternized hydroxyethylcellulose ethoxylate, referred to generally as Polyquaternium-10 and available commercially from Aldrich Chemical Co. of Milwaukee, Wis., was added to make a 1% solution of the cationic polymer. Sodium dodecyl sulfate (SDS), an anionic surfactant, was added in 0.03 g (0.01%) increments. The viscosity was measured with a Chandler model 35 viscometer at 100 rpm (170 sec⁻¹ shear rate) before any surfactant was added, and after each surfactant addition. This example demonstrated the increase in viscosity due to the addition of anionic surfactant to a solution of positively charged polymer. The change in viscosity with the addition of anionic surfactant is shown in Table 2.

TABLE 2
Anionic Surfactant Addition to Positively
Charged Polymer and Effect on Viscosity

| | Apparent viscosity |
|---|---|
| Sodium laurylsulfate % | cP |
| 0 | 36 |
| 0.01 | 36 |
| 0.02 | 39 |
| 0.03 | 48 |
| 0.04 | 62 |
| 0.05 | 84 |
| 0.06 | 120 |
| 0.07 | 156 |
| 0.08 | 228 |
| 0.09 | 304 |
| 0.1 | 373 |
| 0.11 | 439 |
| 0.12 | 523 |
| 0.13 | 589 |
| 0.14 | 628 |
| 0.15 | 667 |
| 0.16 | 643 |

### EXAMPLE 3

The apparent viscosity of a 1% solution of Polyquaternium-10, described above, was measured using a Fann 35 viscometer at 100 rpm. The viscosity was measured again after the addition of 0.06% sodium lauryl sulfate anionic surfactant. As shown in Table 3, the surfactant significantly increased the solution viscosity. Addition of a viscosity-enhancing agent, alpha-sulfo fatty acid monomethyl ester sodium salt, resulted in another dramatic increase in viscosity.

TABLE 3
Effect of Ionic Viscosity Enhancing Agent

| | | Alpha-sulfo fatty | |
|---|---|---|---|
| | | acid monomethyl | |
| % Sodium lauryl sulfate | | ester, sodium salt | Apparent viscosity |
| | 0 | 0 | 33 |
| | 0.06% | 0 | 159 |
| | 0.06% | 0.12% | 711 |

### EXAMPLE 4

The experiment described in Example 3 was repeated with several modifications. This time the amount of sodium lauryl sulfate was increased to 0.1% and dodecyl alcohol was tested as a non-ionic viscosity-enhancing agent. The viscosity increase due to this small amount of dodecyl alcohol was not dramatic. However, as shown in Table 4, it did enhance the viscosity apparently without electrostatically bonding (since it is nonionic) to the Polyquaternium-10.

TABLE 4
Effect of Nonionic Viscosity Enhancing Agent

| Sodium lauryl sulfate | Dodecyl alcohol | Apparent viscosity, cP |
|---|---|---|
| 0 | 0 | 36 |
| 0.1% | 0 | 333 |
| 0.1% | 0.02% | 366 |

Thus, the present invention is well adapted to carry out the objects and attain the benefits and advantages mentioned as well as those that are inherent therein. While numerous changes to the compositions and methods can be made by those skilled in the art, such changes are encompassed within the spirit of this invention as defined by the appended claims.

What is claimed is:

1. A method of treating a subterranean formation comprising the steps of:
(a) preparing a treating fluid composition comprising water, a charged polymer, and a surfactant having a charge that is opposite to that of the charged polymer, said surfactant being capable of forming an ion-pair association with said polymer resulting in a hydrophobically modified polymer having a plurality of hydrophobic groups; and
(b) injecting said treating fluid composition into a well bore to treat said subterranean formation.

2. The method of claim 1 wherein said water is selected from the group of fresh water and salt water and is present in said hydrophobically modified polymer composition in an amount in the range of from about 95% to about 99.9% by weight thereof.

3. The method of claim 1 wherein said charged polymer is an anionic polymer selected from the group consisting of carboxymethyl guar, carboxymethylhydroxypropyl guar, carboxymethylhydroxyethyl cellulose, polyacrylic acid, polyacrylate copolymers, 2-acrylamido-2-methylpropanesulfonic acid and salts, and mixtures thereof.

4. The method of claim 1 wherein said charged polymer is a cationic polymer selected from the group consisting of cationic polyacrylamide copolymers, cationic guar, cationic cellulose derivatives, cationic polysaccharide derivatives, choline methacrylate and mixtures thereof.

5. The method of claim 1 wherein said charged polymer is present in said treating fluid composition in an amount in the range of from about 0.1% to about 2.0% by weight thereof.

6. The method of claim 1 wherein said charged polymer is cationic and said surfactant is an anionic surfactant selected from the group consisting of alpha olefin sulfonate, alkylether sulfates, alkyl phosphonates, alkane sulfonates, fatty acid salts, and arylsulfonic acid salts, and mixtures thereof.

7. The method of claim 1 wherein said charged polymer is anionic and said surfactant is a cationic surfactant selected from the group consisting of trimethylcocoammonium chloride, trimethyltallowammonium chloride, dimethyldicocoammonium chloride, bis(2-hydroxyethyl)tallowamine, bis(2-hydroxyethyl)erucylamine, bis(2-hydroxyethyl)coco-amine, cetylpyridinium chloride, and mixtures thereof.

8. The method of claim 1 wherein said surfactant is present in said treating fluid composition in an amount in the range of from about 0.05% to about 1.0% by weight thereof.

9. The method of claim 1 wherein said charged polymer is carboxymethylhydroxypropyl guar, and said surfactant is trimethyltallowammonium chloride.

10. The method of claim 1 wherein said treating fluid composition further comprises a viscosity-enhancing agent capable of enhancing the formation of micellar bonds between hydrophobic groups on said polymer and/or between hydrophobic groups on adjacent polymer molecules.

11. The method of claim 1 wherein said treating fluid further comprises a viscosity-enhancing agent selected from the group consisting of fatty alcohols, ethoxylated fatty alcohols and amine oxides having hydrophobic chain lengths of C₆ to C₂₂, and mixtures thereof.

12. The method of claim 11 wherein said viscosity-enhancing agent is present in said treating fluid composition in an amount in the range of from about 0.05% to about 1.0% by weight thereof.

13. A method of forming one or more fractures in a subterranean zone penetrated by a well bore comprising the steps of:
(a) preparing a fracturing fluid composition comprising water, a charged polymer, and a surfactant having a charge that is opposite to that of the charged polymer, said surfactant being capable of forming an ion-pair association with said polymer resulting in a hydrophobically modified polymer having a plurality of hydrophobic groups;
(b) introducing said fracturing fluid into said subterranean zone through said well bore under conditions effective to create at least one fracture therein.

14. The method of claim 13 wherein said water is selected from the group of fresh water and salt water and is present in said fracturing fluid composition in an amount in the range of from about 95% to about 99.9% by weight thereof.

15. The method of claim 13 wherein said charged polymer is an anionic polymer selected from the group consisting of carboxymethyl guar, carboxymethylhydroxypropyl guar, carboxymethylhydroxyethyl cellulose, polyacrylic acid, polyacrylate copolymers, 2-acrylamido-2-methylpropanesulfonic acid and salts and mixtures thereof.

16. The method of claim 13 wherein said charged polymer is a cationic polymer selected from the group consisting of cationic polyacrylamide copolymers, cationic guar, cationic cellulose derivatives, cationic polysaccharide derivatives, choline methacrylate and mixtures thereof.

17. The method of claim 13 wherein said charged polymer is present in said fracturing fluid composition in an amount in the range of from about 0.1% to about 2.0% by weight thereof.

18. The method of claim 13 wherein said charged polymer is cationic and said surfactant is an anionic surfactant selected from the group consisting of alpha olefin sulfonate, alkylether sulfates, alkyl phosphonates, alkane sulfonates, fatty acid salts, and arylsulfonic acid salts, and mixtures thereof.

19. The method of claim 13 wherein said charged polymer is anionic and said surfactant is a cationic surfactant selected from the group consisting of trimethylcocoammonium chloride, trimethyltallowammonium chloride, dimethyldicocoammonium chloride, bis(2-hydroxyethyl)tallowamine, bis(2-hydroxyethyl)erucylamine, bis(2-hydroxyethyl)coco-amine, cetylpyridinium chloride, and mixtures thereof.

20. The method of claim 13 wherein said surfactant is present in said fracturing fluid composition in an amount in the range of from about 0.05% to about 1.0% by weight thereof.

21. The method of claim 13 wherein said charged polymer is carboxymethylhydroxypropyl guar, and said surfactant is trimethyltallowammonium chloride.

22. The method of claim 13 wherein said fracturing fluid composition further comprises a viscosity-enhancing agent capable of enhancing the formation of micellar bonds between hydrophobic groups on said polymer and/or between hydrophobic groups on adjacent polymer molecules.

23. The method of claim 13 wherein said fracturing fluid further comprises a viscosity-enhancing agent selected from the group consisting of fatty alcohols, ethoxylated fatty alcohols and amine oxides having hydrophobic chain lengths of C₆ to C₂₂, and mixtures thereof.

24. The method of claim 23 wherein said viscosity-enhancing agent is added to said fracturing fluid composition in an amount in the range of from about 0.05% to about 1.0% by weight thereof.

25. The method of claim 13 wherein said fracturing fluid composition further comprises a proppant material.

26. The method of claim 25 wherein said proppant is selected from the group consisting of sand, graded gravel, glass beads, sintered bauxite, resin coated sand ceramics, and intermediate strength ceramics.

27. The method of claim 25 wherein said proppant is present in said fracturing fluid composition in an amount in the range of from about 0.5 lb/gal to about 24 lb/gal thereof.

28. A method of forming one or more fractures in a subterranean zone penetrated by a well bore comprising the steps of:
(a) preparing a foamed fracturing fluid composition comprising water, a charged polymer, a surfactant having a charge that is opposite to that of the charged polymer, said surfactant being capable of forming an ion-pair association with said polymer resulting in a hydrophobically modified polymer having a plurality of hydrophobic groups, a foaming agent and sufficient gas to form a foam; and
(b) introducing said foamed fracturing fluid into said subterranean zone through said well bore under conditions effective to create at least one fracture therein.

29. The method of claim 28 wherein said foaming agent is a cationic surfactant selected from the group consisting of trimethylcocoammonium chloride, trimethyltallowammonium chloride, dimethyldicocoammonium chloride, bis(2-hydroxyethyl)tallowamine, bis(2-hydroxyethyl)erucylamine, bis(2-hydroxyethyl)coco-amine, cetylpyridinium chloride, and mixtures thereof.

30. The method of claim 28 wherein said foaming agent is an anionic surfactant selected from the group consisting of alpha olefin sulfonate, alkylether sulfates, alkyl phosphonates, alkane sulfonates, fatty acid salts, arylsulfonic acid salts and mixtures thereof.

31. The method of claim 28 wherein said gas is selected from the group consisting of air, nitrogen, carbon dioxide and mixtures thereof.

32. A treating fluid composition for treating a subterranean formation wherein said treating fluid composition comprises:
water;
a charged polymer; and
a surfactant having a charge that is opposite to that of the charged polymer, said surfactant being capable of forming an ion-pair association with said polymer resulting in a hydrophobically modified polymer having a plurality of hydrophobic groups.

33. The composition of claim 32 wherein said water is selected from the group of fresh water and salt water and is present in said treating fluid composition in an amount in the range of from about 95% to about 99.9% by weight thereof.

34. The composition of claim 32 wherein said charged polymer is an anionic polymer selected from the group consisting of carboxymethyl guar, carboxymethylhydroxypropyl guar, carboxymethylhydroxyethyl cellulose, polyacrylic acid, polyacrylate copolymers, 2-acrylamido-2-methylpropanesulfonic acid and salts, and mixtures thereof.

35. The composition of claim 32 wherein said charged polymer is a cationic polymer selected from the group consisting of cationic polyacrylamide, cationic guar, cationic cellulose derivatives, cationic polysaccharide derivatives, choline methacrylate and mixtures thereof.

36. The composition of claim 32 wherein said charged polymer is present in said treating fluid composition in an amount in the range of from about 0.1% to about 2.0% by weight thereof.

37. The composition of claim 32 wherein said charged polymer is cationic and said surfactant is an anionic surfactant selected from the group consisting of alpha olefin sulfonate, alkylether sulfates, alkyl phosphonates, alkane sulfonates, fatty acid salts, and arylsulfonic acid salts, and mixtures thereof. thereof.

38. The composition of claim 32 wherein said charged polymer is anionic and said surfactant is a cationic surfactant selected from the group consisting of trimethylcocoammonium chloride, trimethyltallowammonium chloride, dimethyldicocoammonium chloride, bis(2-hydroxyethyl)tallowamine, bis(2-hydroxyethyl)erucylamine, bis(2-hydroxyethyl)coco-amine, cetylpyridinium chloride, and mixtures thereof.

39. The composition of claim 32 wherein said surfactant is present in said treating fluid composition in an amount in the range of from about 0.05% to about 1.0% by weight thereof.

40. The composition of claim 32 wherein said charged polymer is carboxymethylhydroxypropyl guar, and said surfactant is trimethyltallowammonium chloride.

41. The composition of claim 32 further comprising a viscosity-enhancing agent capable of enhancing the formation of micellar bonds between hydrophobic groups on said polymer and/or between hydrophobic groups on adjacent polymer molecules.

42. The composition of claim 32 further comprising a viscosity-enhancing agent selected from the group consisting of fatty alcohols, ethoxylated fatty alcohols and amine oxides having hydrophobic chain lengths of C₆ to C₂₂, and mixtures thereof.

43. The composition of claim 42 wherein said viscosity-enhancing agent is present in said treating fluid composition in an amount in the range of from about 0.05% to about 1.0% by weight thereof.

44. The composition of claim 32 further comprising a proppant.

45. The composition of claim 44 wherein said proppant is selected from the group consisting of sand, graded gravel, glass beads, sintered bauxite, resin coated sand ceramics, and intermediate strength ceramics.

46. The composition of claim 44 wherein said proppant is present in said treating fluid composition in an amount in the range of from about 0.5 lb/gal to about 24 lb/gal thereof.

47. The composition of claim 32 further comprising an effective amount of a foaming agent and sufficient gas to form a foam.

48. The composition of claim 47 wherein said foaming agent is a cationic surfactant selected from the group consisting of trimethylcocoammonium chloride, trimethyltallowammonium chloride, dimethyldicocoammonium chloride, bis(2-hydroxyethyl)tallowamine, bis(2-hydroxyethyl)erucylamine, bis(2-hydroxyethyl)coco-amine, cetylpyridinium chloride, and mixtures thereof.

49. The composition of claim 47 wherein said foaming agent is an anionic surfactant selected from the group consisting of alpha olefin sulfonate, alkylether sulfates, alkyl phosphonates, alkane sulfonates, fatty acid salts, arylsulfonic acid salts and mixtures thereof.

50. The composition of claim 47 wherein said foaming agent is present in said composition in an amount in the range of from about 0.1% to 2.0% by weight thereof.

51. The composition of claim 47 wherein said gas is selected from the group consisting of air, nitrogen, carbon dioxide and mixtures thereof.
